(19) United States
(12) Patent Application Publication
(10) Pub. No.: US 2007/0120387 A1
(43) Pub. Date: May 31, 2007

(54) Mounting system for a travel trailer

(76) Inventors: Mark A. Bullock, Elkhart, IN (US); Gerald Lee Clark, Milford, IN (US)

Correspondence Address: DINSMORE & SHOHL LLP;One Dayton Centre, Suite 1300, One South Main Street, Dayton, OH, 45402-2023, US

(21) Appl. No.: 11/414,957

(22) Filed: May 1, 2006

Related U.S. Application Data
(60) Provisional application No. 60/740,238, filed on Nov. 28, 2005.

(51) Int. Cl. B62D 24/04

(52) U.S. Cl. 296/1.03; 296/35.1

(57) ABSTRACT

A device and method for reducing vibration in a travel trailer. In one form, a vibration isolation member includes an elastic sandwich structure that forms part of a mounting system that connects an enclosure that defines a living space therein to a frame on the trailer. By placing the compliant part of the sandwich structure substantially along a gravitational axis, vibrations imparted to the device from the frame are absorbed in shear, causing a reduction in vibration transmitted to the travel trailer enclosure.

This application claims the benefit of the filing date of U.S. Provisional Application No. 60/740,238, filed Nov. 28, 2005.

### BACKGROUND OF THE INVENTION

The present invention relates generally to improvements to a travel trailer and related recreational vehicles, and more particularly to secure the travel trailer floor to the drawbar assembly through a compliant structure to promote vibration isolation between the two.

Travel trailers are a popular form of recreational vehicle that can be hitched to and towed by another motive vehicle (such as a pickup truck, sport utility vehicle or the like). The upper portion of a typical travel trailer includes an enclosure that defines living or storage space within, while the lower portion includes support structure for the enclosure. Together, they define a body-on-frame construction. The support structure typically includes a frame, wheels, hitch, drawbar assembly and related components. The frame generally includes a box-like structure with one or more substantially longitudinally-extending members coupled to one or more cross members. In one form, the drawbar assembly forms an A-shaped extension from the forward end of the frame, and terminates at the hitch. In one form, the drawbar assembly is rigidly affixed to or forms an integral part of the frame. In another, the drawbar assembly can be pivotally mounted to the frame to improve towing quality, especially over rough or undulated roads or terrain.

It is desirable to increase the amount of living or storage space within a typical travel trailer. For example, the front of a travel trailer may be expanded to take advantage of available space above the drawbar assembly. Nevertheless, such expansion has not been employed in travel trailers, owing to the relatively large amount of flex present in travel trailer drawbar assemblies compared to those of more robust vehicles, such as cargo trailers. Moreover, the presence of slideouts, windows and multiple entry doors in a travel trailer weakens the enclosure structure that necessitates the use of robust structural reinforcements to improve the rigidity of the enclosure, which contributes to significant increases in travel trailer weight.

Prior attempts to overcome the extra load involve hard mounting the floor of the enclosure to the drawbar assembly, either directly or through a separate floor frame. Unfortunately, the flexing nature of the drawbar assembly lead to various separation problems, including separation of the floor from the drawbar and separation of the enclosure walls from the floor. Accordingly, there is a need for a way to secure the enclosure of a travel trailer to the trailer support structure such that forward-extending enclosure profiles can be adequately supported on a drawbar assembly without damaging the connection between them.

### SUMMARY OF THE PRESENT INVENTION

These needs are met by the present invention, wherein a device for use in travel trailers without the aforementioned disadvantages is described. In accordance with one aspect of the present invention, a mounting system for a travel trailer is disclosed. The mounting system includes a frame that can support a travel trailer living space, and a vibration isolation member. The frame (also referred to as a support frame) can be coupled to wheels to allow rolling movement of the trailer when attached to a suitable motive vehicle. The frame is made up of first and second segments, where the second segment includes a substantially forward extension of the first segment. In the present context, the term “substantially” refers to an arrangement of elements or features that, while in theory would be expected to exhibit exact correspondence or behavior, may, in practice embody something slightly less than exact. As such, the term denotes the degree by which a quantitative value, measurement or other related representation may vary from a stated reference without resulting in a change in the basic function of the subject matter at issue. The vibration isolation member cooperates with the second segment such that once the living space is placed on the frame, vibratory movement between the second segment and the living space is reduced as the relative movement between the two passes through the vibration isolation member. As understood in the present context, the term “mounting system” is meant to describe either collectively or individually the components making up the support for the travel trailer, and such usage will be apparent from the context.

Optionally, the vibration isolation member comprises a viscoelastic material, such as rubber, or plastics that produce rubber-like responses when subjected to a force or movement in response to such a force. In contrast to an elastic material, the modulus of elasticity in a viscoelastic material is modeled as a complex quantity in that it includes both a real (stiffness) component and an imaginary (dissipative) component. The dissipative component, which may be thought of as a loss factor, is related to how much the viscoelastic material absorbs vibratory energy. One way this behavior is manifested is through a conventional stress-strain curve, where a viscoelastic material exhibits a significant amount of hysteresis. Since viscoelastic materials tend to have reduced load-bearing properties relative to more rigid, elastic materials, one preferred form includes mounting or otherwise placing the viscoelastic material between a pair of substantially rigid plates to define a laminated (i.e., sandwich-like) structure. Adhesives, fasteners or the like can be used to secure the material to the plates. In a more particular form, one of the plates making up the laminated structure is affixed to the frame's second (i.e., forward) segment and one of the plates defining the laminated structure is cooperative with the living space. In the present context, the term “cooperative”, while capable of the same level of connectivity between components as “affixed”, “connected”, “attached” or the like, generally permits a less restrictive degree of engagement. For example, to cooperate with one another, a cause by one component produced an effect in the other, even if an intermediate component is used to effect such cooperation. The viscoelastic material may be formed in a nonlinear shape, thereby encouraging movement along a preferred dimension. In one form, the material defines a substantially parabolic outer shape between the substantially rigid plates, which may be placed in a substantially parallel arrangement relative to one another. In this way, the laminated structure may define length, thickness and width dimensions (as the terms are understood in a Cartesian coordinate system), where the viscoelastic material is oriented such that vibratory movement imparted to it is predominantly along one of the longer (preferably the longest) of the dimensions. Since the longer dimensions of a viscoelastic material display an enhanced level of compliance relative to the shorter dimensions, it is believed that by substantially aligning the longer dimensions and the direction of the movement causing the vibration, more vibratory energy can be imparted to, and subsequently absorbed by, the material. As used in the present invention, the vibration isolation member (at least its viscoelastic material portion) can be aligned to absorb substantially vertical vibratory movement from the frame or a living space placed on the frame. The viscoelastic material may be made from rubber, plastic or other material exhibiting similar time-dependent stress-strain or lossy (i.e., vibration-absorbing) behavior. The second segment may define a drawbar assembly that defines a tapered shape (such as an A-shape) relative to that of the first segment. The mounting system may further include a floor frame disposed over and cooperative with the vibration isolation member such that upon the placement of the living space upon the frame, the second segment, the vibration isolation member and the floor frame define a substantially continuous path through which the movement may pass. In a particular form, the vibration isolation member may be rigidly affixed at one end to the frame (preferably the second segment thereof) and at the other end to either or both of the floor frame and the living space. In one form, the second segment may be affixed to or integral with the first segment, while in another it may be pivotally connected.

According to another aspect of the invention, a travel trailer is disclosed. The travel trailer includes a living space comprising a forward living compartment and a rear living compartment, a frame (with first and second segments as previously discussed) configured such that the rear living compartment is predominantly supported by the first segment and the forward living compartment is predominantly supported by the second segment. Numerous wheels are connected to the first frame segment, while a vibration isolation member is disposed between the second segment and the forward living compartment. In this way, vibratory movement between them is reduced by the dissipative action of the vibration isolation member.

Optionally, the travel trailer further includes a hitch affixed to the second segment so that the travel trailer can be connected to a motive vehicle. In one optional embodiment, the forward living compartment and the rear living compartment define a continuous living compartment. As with the previous embodiment, a floor frame can be disposed between the vibration isolation member and the forward living compartment such that the second segment, the vibration isolation member, the floor frame and the forward living compartment define a substantially continuous path through which the movement may pass in order to allow it to be reduced by the operation of the viscoelastic material. Also as before, the vibration isolation member includes a viscoelastic material disposed between a pair of substantially rigid plates to define a laminated structure, where in a more particular form, one of the plates defining the laminated structure is affixed to the second segment and one of the plates defining the laminated structure is affixed to the floor frame, the forward living compartment, or both. To best take advantage of the viscoelastic material's damping properties, the largest of the length, thickness and width dimensions of the viscoelastic material is substantially coplanar with the direction of movement between the frame and the living space.

The A-shaped forward projection of the living space is positioned over the drawbar assembly. This provides a V-shaped extension to the living space that increases the area within the enclosure without a corresponding increase in the length of the unit beyond the frame. Stated another way, the forward living compartment can employ (when looking in plan view from a forward end of the trailer) a substantially V-shaped forward end. In the present context, terms of spatial reference, such as “V-shaped” and “A-shaped”, are to be understood in light of viewer orientation for the sake of clarity in describing the examples and embodiments of the invention described herein. The aerodynamically-enhanced front end features adds aesthetic appeal and a lower drag profile with concomitant reduction in fuel consumption. As stated above, the forward-extending living space defined by the V-shaped extension can either be mounted directly onto the vibration isolation member, or onto a floor frame that in turn can be affixed or otherwise made cooperative with the vibration isolation member. In this way, the forward portion of the enclosure's V-shaped extension is now supported by the mounting system, rather than being cantilevered. In one form, the viscoelastic material of the vibration isolation member forms of a rubber shear plate such that the two substantially rigid plates used to form the laminated structure with the viscoelastic material are moving in generally opposite directions of each other. By orienting the vibration isolation member of the mounting system in such a way as to absorb the majority of loads imparted to it from the drawbar assembly, it reduces vibrations to the enclosure. In one particular embodiment, the viscoelastic material is sandwiched between rigid mounting plates in the form of a bracket. The bracket of the mounting system can be welded, bolted or otherwise fastened to the drawbar assembly (such as to a crossbar). In one particular form, the portion of the bracket that is connected to the enclosure is fastened to the underside of the floor assembly, using (for example) lag screws that can engage the wooden floor, sub-floor or the like. In another, where a floor frame is used, the bracket can be affixed to the floor frame.

According to yet another aspect of the invention, a method of reducing vibrations within a travel trailer is disclosed. The method includes configuring the travel trailer to comprise a support frame and an enclosure disposed on the support frame, where the enclosure defines a living space within, arranging a vibration isolation member to be disposed between respective portions of the support frame and living space, imparting a load to the support frame such that relative movement between the support frame and the living space is initiated, and passing the relative movement through the vibration isolation member such that the magnitude of the relative movement is reduced by viscoelastic losses set up within the vibration isolation member. One way in which the load can be imparted is to transport the travel trailer over roads, paths or other surfaces upon which a travel trailer can be expected to move.

Optionally, the configuration of the travel trailer may include a forward living compartment and a rear living compartment within the living space. Similarly, the support frame may be made from first and second segments such that the second segment forms a substantially forward extension of the first segment in a manner similar to that previously discussed, while the living space can be placed on the support frame such that the rear living compartment is predominantly supported by the first segment and the forward living compartment is predominantly supported by the second segment. The way to take best advantage of the material properties of the vibration isolation member is to substantially align the most compliant of the length, thickness and width dimension of the viscoelastic material with a direction of motion of the relative movement. One form of arranging the vibration isolation member comprises affixing one portion of the vibration isolation member to the support frame, and placing another portion of the vibration isolation member in cooperative arrangement with the living space, aforementioned floor frame, or both. As discussed in conjunction with the previous embodiments, the viscoelastic losses are predominantly formed within viscoelastic material disposed between a pair of substantially rigid plates. More particularly, one of the plates can be affixed to the second segment and one of the plates affixed to the floor frame. As also mentioned before, the viscoelastic material can be made from a nonlinear shape between the plates, where such shape could include a substantially parabolic shape.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is a perspective front view of a travel trailer with a V-shaped forward extension;

FIG. 2 shows a front view of the travel trailer of FIG. 1;

FIG. 3 is a perspective view of the placement of the V-shaped forward extension relative to a drawbar assembly portion of the travel trailer's frame;

FIG. 4 shows an upward perspective view of how the vibration isolation member of the mounting system is attached to the travel trailer frame according to an embodiment of the present invention;

FIG. 5 shows the another upward perspective view of the vibration isolation member placed between two plates that are in turn attached to the travel trailer frame of FIG. 4;

FIG. 6 shows the another upward perspective view of the vibration isolation member and plates attached to the travel trailer frame of FIG. 4;

FIG. 7 shows the another upward perspective view of the position of the vibration isolation member relative to the travel trailer frame of FIG. 4;

FIG. 8 shows a perspective view of the bracket of the mounting system that is used to surround a shear plate for vibration isolation;

FIG. 9 shows a side elevation view of the vibration isolation member connected between the frame and the floor of a travel trailer living space; and

FIG. 10 shows a perspective view of a forward portion of the frame, including the drawbar assembly.

### DETAILED DESCRIPTION OF THE PREFERRED EMBODIMENTS

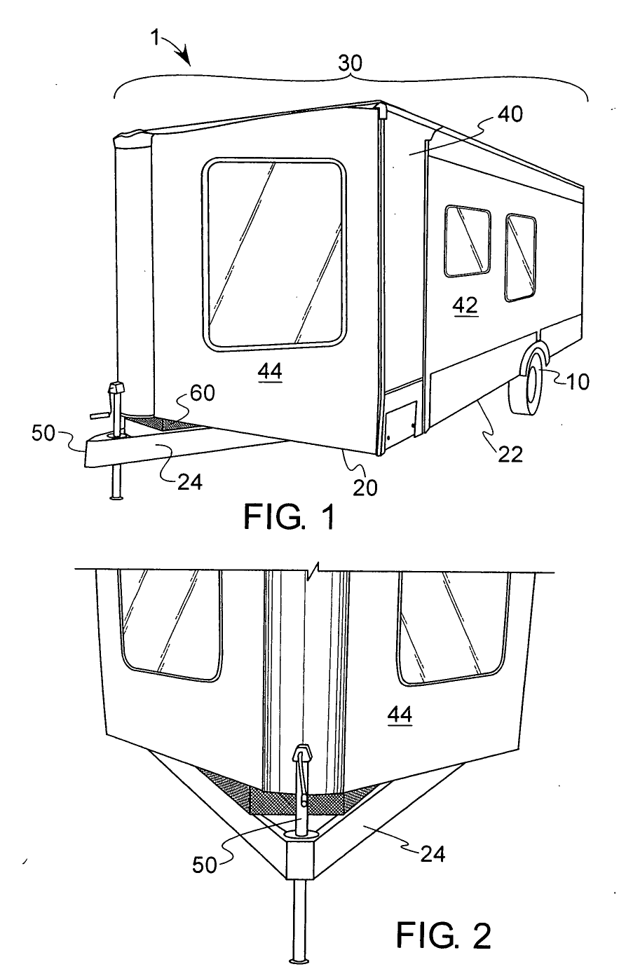

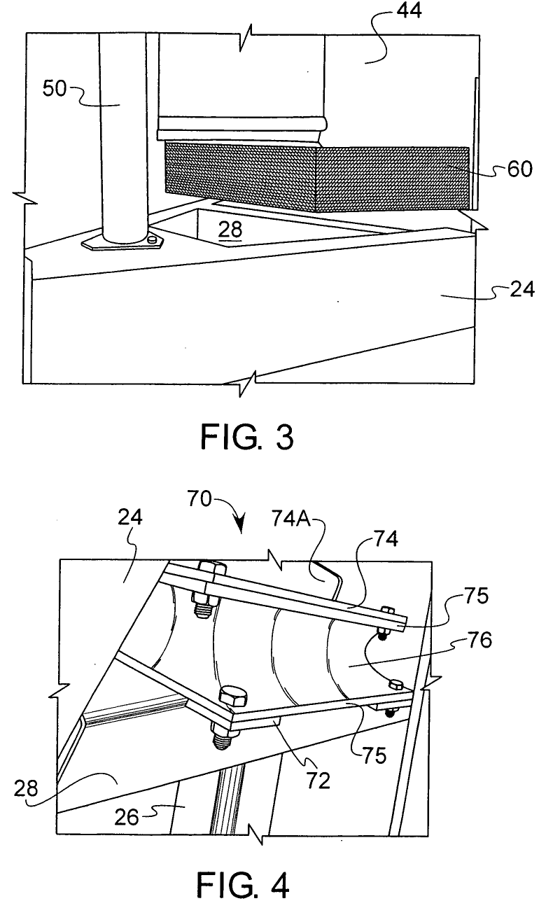

Referring first to FIGS. 1 through 3 and 10, a recreational vehicle in the form of a travel trailer 1 includes wheels 10, a frame 20 supported on wheels 10 and an enclosure 30 defining a living space 40 formed therein. The frame 20 includes a first segment 22 and a second segment 24 that extends in a generally forward direction relative to the first segment 22. In a preferred form, frame 20 includes longitudinal members 26 and lateral (or crossbar) members 28. In one form, the second segment 24 (which is alternately referred to as the drawbar assembly), is affixed to the first segment (such as through welding, fastening or the like) such that it defines an integral (albeit tapered) A-shaped extension of the first segment 22. In another (not shown) the second segment 24 can be pivotally attached to the first segment 22, thereby permitting at least one degree of freedom (that being the rotational degree of freedom about a lateral Y-axis as understood in a conventional Cartesian coordinate system). A door and one or more windows may be formed in the walls of enclosure 30. Enclosure 30 is situated on the frame 20 such that the living space 40 is generally bounded by a floor, roof, side walls, front wall, and rear wall. Living space 40 includes a rear living compartment 42 and a forward living compartment 44, each of which is generally disposed over and supported by corresponding first and second frame segments 22, 24. As can be seen, both the forward living compartment 44 and the second segment 24 define a V-shaped forward portion of the travel trailer 1. A hitch 50 extends from the second segment 24 of frame 20 to enable the travel trailer 1 to be connected to a towing or other motive vehicle (not shown). It will be appreciated by those skilled in the art that the present invention is applicable to other forms of recreational vehicles the configurations of which are also considered to fall within the scope of the present invention. As seen with particularity in FIG. 3, a gap is formed between the lower portion of the forward living compartment 44 and the top of the second segment 24 of frame 20 to allow placement of a floor frame 60. As discussed below, the floor frame 60 may be used as an intermediary between the forward living compartment 44 and a vibration isolation member 70 that is connected to the top of the second segment 24 of frame 20.

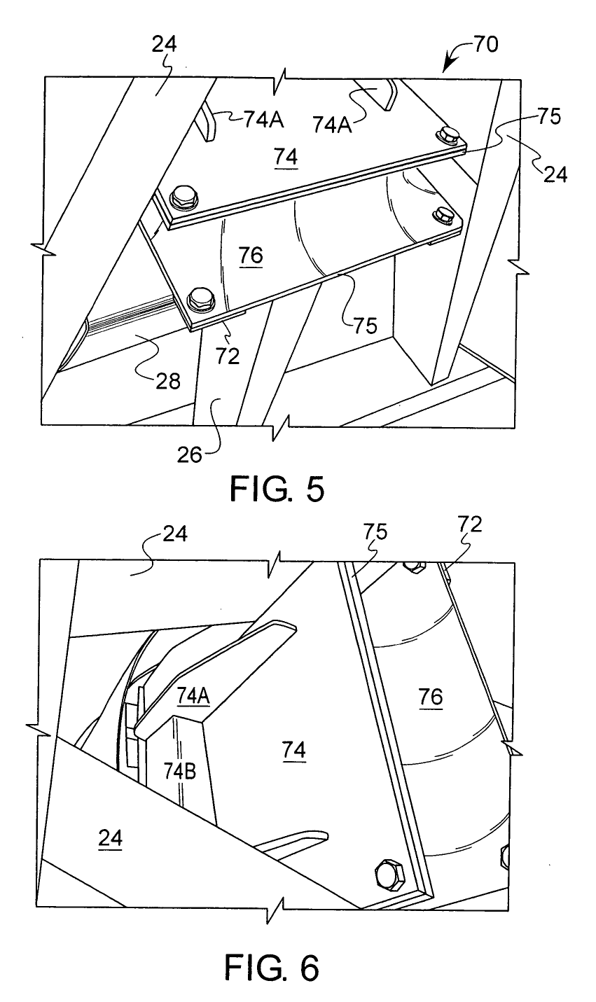

Referring next to FIGS. 4 through 9, details pertaining to the vibration isolation member 70 and how it cooperates with the remainder of the mounting system and travel trailer 1 are shown. As can be seen in the figures, the mounting system includes vibration isolation member 70, which is made up of a pair of rigid metal mounting plates 72, 74 surrounding a layer of viscoelastic material 76 that is placed between and affixed to plates 72, 74 through a corresponding pair of joining plates 75. Such construction allows vibration isolation member 70 to function as elastic shear plate. In a particular form, the joining plates 75 can be coupled to the layer of viscoelastic material 76 through molding, adhesives, fasteners or related joining techniques. In a more particular form, the joining plates 75 can be of a rigid metal, similar to mounting plates 72, 74. As shown with particularity in FIG. 4, fasteners, in the form of a nut and bolt, can be used to secure the layer of viscoelastic material 76 to the joining plates and corresponding mounting plates. The mounting plates 72, 74 are generally rectangular and spaced apart in a facing fashion such that together they define a bracket that at a lower end can be welded, fastened or otherwise fixedly connected to the crossbar 28 of the second segment 24 of frame 20, while the upper end can be used to allow connection to the floor of the enclosure 30 or the floor frame 60. In a particular form, the viscoelastic material 76 (which may be thought of as an elastic shear plate) is made from rubber, and is sandwiched between the two joining plates 75 and the two rigid mounting plates 72, 74. The relatively compliant nature of the viscoelastic material 76 (which can be further controlled by judicious choice in shape, such as the generally parabolic shape as shown in the figures) allows movement imparted to the mounting plate 72 from the drawbar assembly 24 or other part of the trailer frame to be transferred to and absorbed by the viscoelastic material 76. In this way, the amount of movement that is transferred to the mounting plate 74 and enclosure 30 cooperative therewith is reduced or eliminated. Such reduction in vibration of the portion of the enclosure 30 that is situated above the second segment 24 of frame 20 is beneficial, as otherwise, the larger amount of movement of the more flexible second segment 24 relative to the more rigid first segment 22 would tend to push and pull the rear living compartment 42 relative to the forward living compartment 44, potentially causing damage to the enclosure 30.

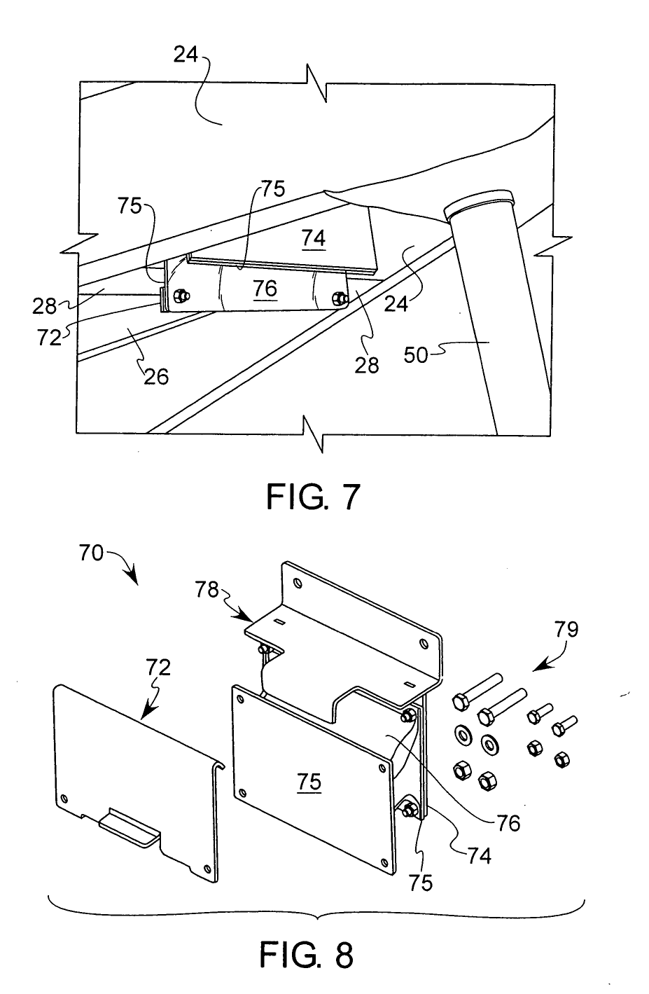

Referring with particularity to FIG. 6, features of mounting plate 74 are shown, including ribs 74A and pedestal 74B. The ribs 74A can be used to provide additional stiffness in the generally planar plate, while pedestal 74B can be used to improve mounting between the upper end of mounting plate 74 and either the floor of the enclosure 30 or the floor frame 60 (neither of which are presently shown). By performing their stiffening function, ribs 74A promote vertical movement, while reducing horizontal (i.e., through-the-thickness) in vibration isolation member 70. Referring with particularity to FIG. 7, it can be seen that the mounting plates 72, 74 can be vertically offset from one another such that the edges of the mounting plates 72, 74 are not completely coextensive with one another.

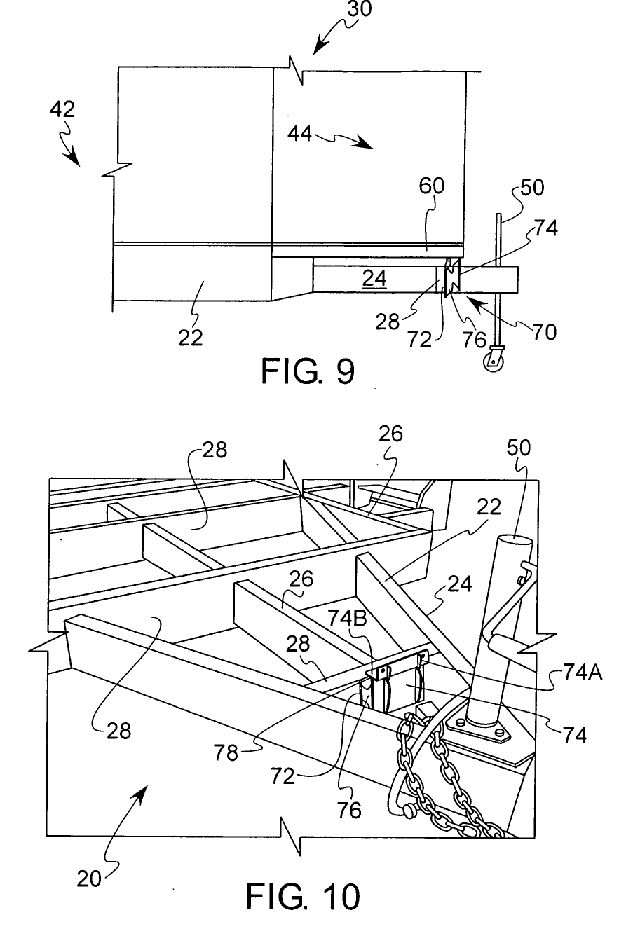

Referring with particularity to FIGS. 8 through 10, placement of the vibration isolation member 70 relative to the frame and enclosure is shown. FIG. 8 shows the vibration isolation member 70, along with an upper mounting brace 78 and fasteners 79. As further shown in FIG. 8, mounting plate 72 is separate from, but an integral part of, the vibration isolation device. In one configuration, mounting plate 72 is welded on to frame 20 by a manufacturer of the frame. Mounting plate 72 is shaped with a lip at the top to make it easier to mount to joining plate 75. When it comes time to mount the vibration isolation member to frame 20, fasteners (such as bolts) are installed through apertures formed near the lowermost edge of mounting plate 72, while the lip is used to overhang the uppermost edge of joining plate 75. This avoids having to install fasteners in the relatively tight and inaccessible portion of mounting plate 72. Typically, the assembly making up the vibration isolation member 70 is not bolted into place until the travel trailer is almost completely assembled. An alignment device, such as a small bottle jack, can be used to align the apertures formed in joining plate 75 to the corresponding apertures of mounting plate 72, which (as mentioned above) is already welded top frame 20. This allows a preload to be applied to the vibration isolation member 70. Referring with particularity to FIG. 9, a side elevation view shows the placement of the vibration isolation member 70 as part of the overall mounting system of the enclosure 30 relative to the frame 20. In a preferred (but not necessarily required) orientation, one of the mounting plates 72 of the vibration isolation member 70 is affixed to crossbar 28 of frame 20 while the other of the mounting plates 74 is either affixed to or at least in substantial contact with floor frame 60 (as shown) or the lower surface of the floor of enclosure 30 such that the longer of the viscoelastic material's 76 dimensions is substantially vertically aligned. In such an orientation, the smaller through-the-thickness dimension of the viscoelastic material 76 is arranged a generally horizontal axis. This alignment of one of the more compliant longer dimensions promotes greater absorption of vibratory (and related movement) energy into the lossy layer of the viscoelastic material 76. As discussed above, the level of compliance of the viscoelastic material 76 can be additionally adjusted by changing its shape. As can be seen in FIG. 9, the viscoelastic material 76 defines a substantially parabolic through-the-thickness shape. As shown with particularity in FIG. 10, the second segment 24 of frame 20 is more shallow in the vertical dimension than the first segment 22. As described above, such allows for more flex in the second segment 24 relative to the first segment 22, thereby making the inclusion of the vibration isolation member 70 an important component in establishing a properly functioning mounting system. The reduced thickness of this part of frame 20 also allows for the placement of floor frame 60 on top of second segment 24 such that the floor frame 60 does not substantially intrude into the aforementioned forward living compartment 44. The horizontal portion of upper brace 78 can be used to support the weight of the floor of enclosure 30, while the vertical portion of upper brace 78 can be used to secure the assembly of components making up the vibration isolation member 70 to the enclosure 30 to inhibit horizontal movement thereof.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A mounting system for a travel trailer living space, said mounting system comprising:
a frame comprising a first segment and a second segment, said second segment comprising a substantially forward extension of said first segment; and
a vibration isolation member cooperative with said second segment such that upon placement of said living space upon said frame, vibratory movement between said second segment and said living space is reduced by passage of said movement through said vibration isolation member.

2. The mounting system of claim 1, wherein said vibration isolation member comprises a viscoelastic material.

3. The mounting system of claim 2, wherein said viscoelastic material is disposed between a pair of substantially rigid plates to define a laminated structure.

4. The mounting system of claim 3, wherein one of said plates defining said laminated structure is affixed to said second segment and one of said plates defining said laminated structure is cooperative with said living space.

5. The mounting system of claim 4, wherein said viscoelastic material defines a substantially parabolic outer shape between said substantially rigid plates.

6. The mounting system of claim 5, wherein said laminated structure defines a length dimension, a thickness dimension and a width dimension, and wherein said viscoelastic material is oriented such that said movement imparted thereto is predominantly along a longest of said dimensions.

7. The mounting system of claim 2, wherein said viscoelastic material comprises rubber.

8. The mounting system of claim 1, wherein said second segment comprises a drawbar assembly that defines a tapered shape relative to that of said first segment.

9. The mounting system of claim 1, wherein said vibration isolation member is configured to absorb substantially vertical vibratory movement from said second segment.

10. The mounting system of claim 1, further comprising a floor frame disposed over and cooperative with said vibration isolation member such that upon said placement of said living space upon said frame, said second segment, said vibration isolation member and said floor frame define a substantially continuous path through which said movement may pass.

11. The mounting system of claim 1, wherein said second segment is pivotally connected to said first segment.

12. A travel trailer comprising:
a living space comprising a forward living compartment and a rear living compartment;
a frame configured to support said living space, said frame comprising a first segment and a second segment that forms a substantially forward extension of said first segment, said frame configured such that said rear living compartment is predominantly supported by said first segment and said forward living compartment is predominantly supported by said second segment, said first segment comprising a plurality of wheels connected thereto; and
a vibration isolation member disposed between said second segment and said forward living compartment such that vibratory movement therebetween is reduced by passage of said movement through said vibration isolation member.

13. The travel trailer of claim 12, further comprising a hitch affixed to said second segment and configured to connect said travel trailer to a motive vehicle.

14. The travel trailer of claim 12, wherein said forward living compartment and said rear living compartment define a continuous living compartment.

15. The travel trailer of claim 12, further comprising a floor frame disposed between said vibration isolation member and said forward living compartment such that said second segment, said vibration isolation member, said floor frame and said forward living compartment define a substantially continuous path through which said movement may pass.

16. The travel trailer of claim 15, wherein said vibration isolation member comprises a viscoelastic material disposed between a pair of substantially rigid plates to define a laminated structure, wherein one of said plates defining said laminated structure is affixed to said second segment and one of said plates defining said laminated structure is affixed to said floor frame.

17. The travel trailer of claim 16, wherein a largest of a length dimension, a thickness dimension and a width dimension of said viscoelastic material is substantially coplanar with the direction of said movement between said second segment and said forward living compartment.

18. A method of reducing vibrations within a travel trailer, said method comprising:
configuring said travel trailer to comprise a support frame and an enclosure disposed on said support frame, said enclosure defining a living space therein;
arranging a vibration isolation member to be disposed between at least a portion of said support frame and at least a portion of said living space;
imparting a load to said support frame such that relative movement between said support frame and said living space is initiated; and
passing said relative movement through said vibration isolation member such that the magnitude of said relative movement is reduced by viscoelastic losses set up within said vibration isolation member.

19. The method of claim 18, wherein said configuring said travel trailer comprises:
defining a forward living compartment and a rear living compartment within said living space;
defining a first segment and a second segment within said support frame such that said second segment forms a substantially forward extension of said first segment; and
disposing said living space on said support frame such that said rear living compartment is predominantly supported by said first segment and said forward living compartment is predominantly supported by said second segment.

20. The method of claim 18, wherein said arranging said vibration isolation member to be disposed between at least a portion of said support frame and at least a portion of said living space comprises substantially aligning a most compliant of a length dimension, a thickness dimension and a width dimension of a viscoelastic material within said vibration isolation member with a direction of motion of said relative movement.

21. The method of claim 18, wherein said arranging said vibration isolation member to be disposed between at least a portion of said support frame and at least a portion of said living space comprises affixing one portion of said vibration isolation member to said support frame, and placing another portion of said vibration isolation member in cooperative arrangement with said at least a portion of said living space.

22. The method of claim 18, wherein said viscoelastic losses are predominantly formed within a viscoelastic material disposed between a pair of substantially rigid plates, wherein one of said plates is affixed to said second segment and one of said plates is affixed to said floor frame.

23. The method of claim 22, wherein said viscoelastic material defines a nonlinear shape between said plates.

24. The method of claim 23, wherein said nonlinear shape defines a substantially parabolic shape.
